(19) United States
(12) Patent Application Publication
(10) Pub. No.: US 2008/0164842 A1
(43) Pub. Date: Jul. 10, 2008

(54) Device With a Power Tool Case

(75) Inventor: Joao Jorge Bergner, Aidlingen (DE)

Correspondence Address: Striker, Striker & Stenby, 103 East Neck Road, Huntington, NY, 11743, US

(73) Assignee: ROBERT BOSCH GMBH, Stuttgart (DE)

(21) Appl. No.: 10/585,048

(22) PCT Filed: Oct. 21, 2005
(86) PCT No.: PCT/EP05/55456

§ 371 Date: Jun. 29, 2006

(30) Foreign Application Priority Data
Dec. 15, 2004 (DE) 10 2004 060 294.8

(51) Int. Cl. H02J 7/02; H02J 7/00; B25H 3/00

(52) U.S. Cl. 320/111; 320/115

(57) ABSTRACT

The present invention is directed to a device with a power tool case (10)—that includes at least one receiving area (12) for a power tool (16)—and a charger (14).

It is provided that the charger (14) and the power tool case (10) are designed to remain connected during a charging procedure.

### BACKGROUND INFORMATION

The present invention is directed to a device with a power tool case according to the definition of the species in claim 1.

Devices are known that include a power tool case with a receiving area for a power tool, a rechargeable battery and a charger. To charge the rechargeable battery, the charger and the rechargeable battery must be removed from the power tool case.

### ADVANTAGES OF THE INVENTION

The present invention is directed to a device with a power tool case—that includes at least one receiving area for a power tool—and a charging device.

It is provided that the charger and the power tool case are designed to remain connected during a charging procedure. In this context, the term “designed” is intended to mean, in particular, “equipped”, “configured” and/or “positioned”. Comfort can be enhanced by the means of attaining the object according to the present invention, and it can be ensured, in particular, that the power tool and the charger are transported together to a work site and away from the work site using the power tool case.

It is also provided that the power tool case includes an installation space for the charger, and that the charger is designed to remain in the installation space of the power tool case during the charging procedure. The charger can be transported, always advantageously protected, in the power tool case, and the power tool and/or a rechargeable battery can be conveniently charged directly in the power tool case without the need for an operator to first remove the charger from the power tool case.

As an alternative or in addition, the charger could be located on an exterior side of the power tool case and/or it could also be connected with the power tool case during the charging procedure via a special connecting means, thereby enabling the charger to be removed from the installation space of the power tool case or detached from the exterior side without disconnecting the charger from the power tool case. Possible connecting means in this case would be a cord and/or a flexible flap integrally moulded on the power tool case.

If the connection between the charger and the power tool case is designed to be detachable, flexibility of use can be increased.

The charger can be connected with the power tool case without any special fastening means or, particulary advantageously, via at least one detachable fastening means, by way of which it can be reliably ensured that the connection will not accidentally become disconnected.

Preferably, the fastening means are designed to be actuated without the use of tools, by way of which it is made possible, in particular, for the connection between the charger and the power tool case to be disconnected and reconnected quickly and easily. The fastening means can be provided in the form of various means that appear reasonable to one skilled in the art, e.g., as a detent element, a latch hook, etc.

Comfort can be increased even further when the charger includes a wind-up device for a power cord. The wind-up device can include a storage means onto which the cord can be manually wound, or it can advantageously include a driven storage means, by way of which the cord can be wound up at least partially automatically.

In a further embodiment of the present invention it is provided that the charger is designed as a stand for the power tool. With regard for the term “stand”, it should be pointed out in particular that the power tool can be easily positioned in the charger by holding it by its handle, and it can be removed from the charger via its at least substantially easily accessible handle.

If the charger has a receiving area in which the power tool is capable of being positioned and, in particular, inserted, at least substantially in the machining direction, comfort can be increased, in particular due to the fact that the power tool is basically designed to be moved in its machining direction. It is also feasible, however, that the power tool is designed, i.e., configured and/or equipped, to be inserted in the charger in a direction that is not the machining direction, e.g., with a handle end in the front, etc.

It is furthermore provided that the charger includes a coupling unit designed to correspond with a coupling unit of a power tool unit, i.e., a power tool and/or a rechargeable battery, while the stand function is being performed and to at least transmit charging energy, by way of which it can be easily achieved that the power tool can be charged, in particular, for as long as the power tool is connected with the charger.

The charger can be designed to charge a rechargeable battery in the installed state on the power tool, or in the un-installed state. Advantageously, the charger includes a receiving area for a power tool and a replacement power pack, by way of which a replacement power pack can always be charged in parallel with another replacement power pack during operation of the power tool, so that power supply is ensured, in particular during non-stop operation.

### DRAWING

Further advantages result from the description of the drawing, below. An exemplary embodiment of the present invention is shown in the drawing. The drawing, the description and the claims contain numerous features in combination. One skilled in the art will also advantageously consider the features individually and combine them to form further reasonable combinations.

FIG. 1 shows a device with an opened power tool case—in which a power tool is stored in its transport position—and a charger,

FIG. 2 shows the device in FIG. 1 during a charging procedure, in a top view,

FIG. 3 shows the device in FIG. 1 during a charging procedure, in a side view, and

FIG. 4 shows the charger in a component drawing after having been removed from the power tool case.

### DETAILED DESCRIPTION OF THE EXEMPLARY EMBODIMENT

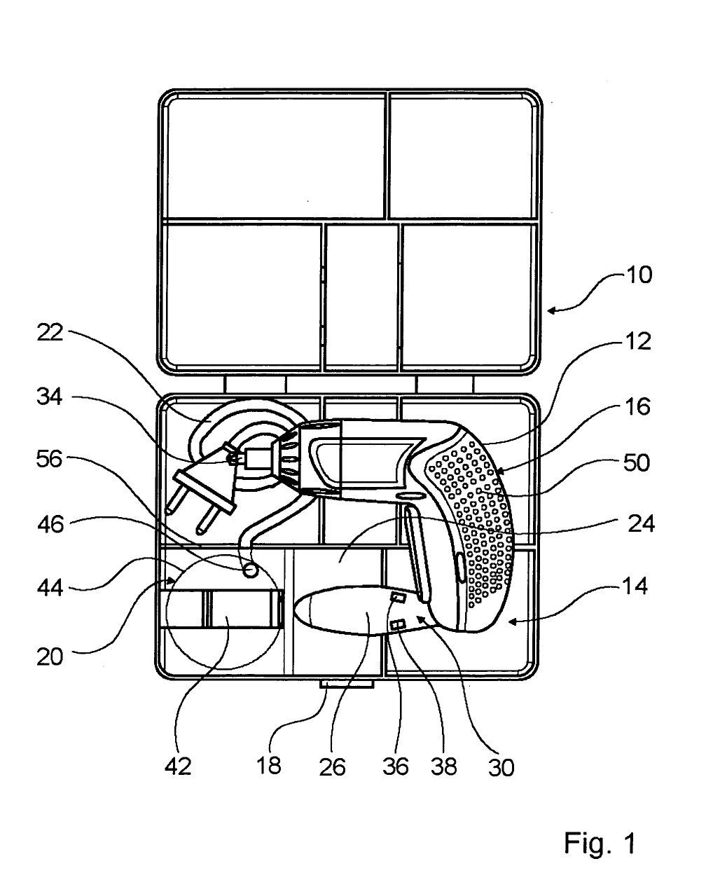

FIG. 1 shows a device with an opened power tool case 10 with a receiving area 12 for a power tool 16—a cordless screwdriver in this case—in which power tool 16 is stored in its transport position. The device also includes a charger 14 that is located inside an installation space 24 of power tool case 10.

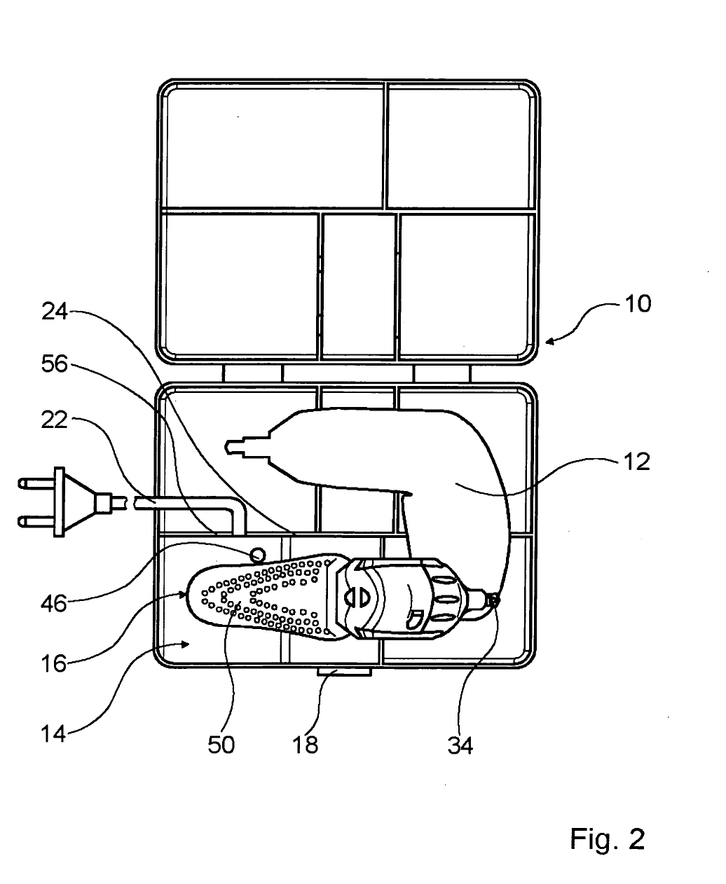

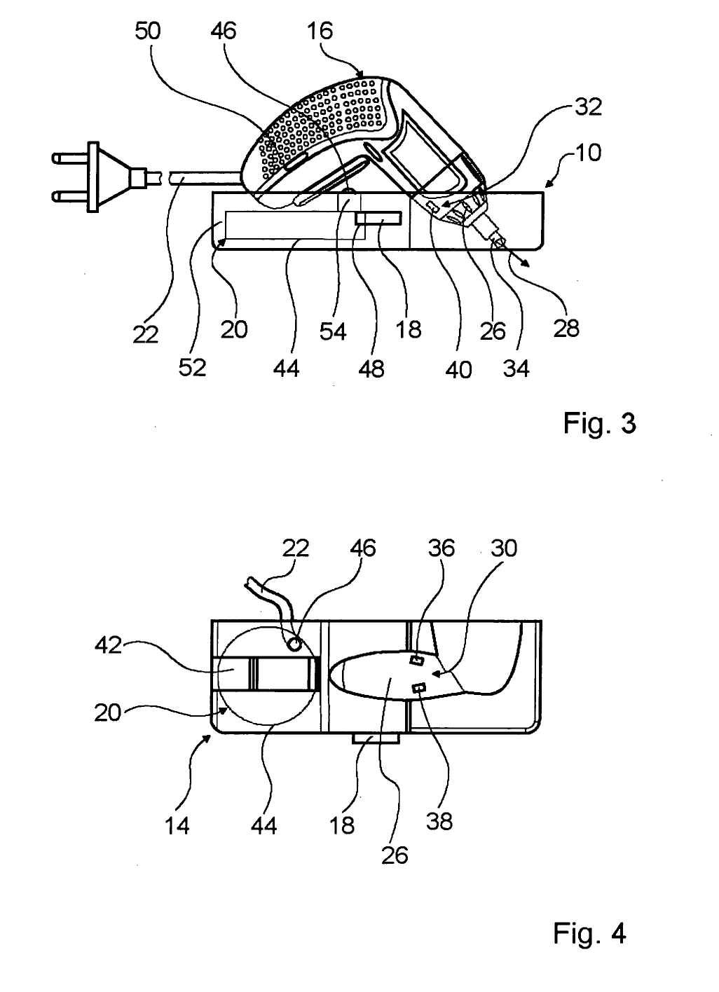

Charger 14 and power tool case 10 are designed to remain connected with charger 14 during a charging procedure of a rechargeable battery integrated in power tool 16 and, in fact, charger 14 is designed, in particular, to remain in installation space 24 of power tool case 10 (FIGS. 2 and 3). Charger 14 is designed as a stand for power tool 16 and, in fact, charger 14 includes a receiving area 26 on its top side in which power tool 16 is capable of being positioned in machining direction 28 of power tool 16 or in the longitudinal direction of an inserted screwdriver bit 34 without the need to remove charger 14 from installation space 24. When power tool 16 is in the inserted state, it is also secured in a fixed position via its handle 50 in a specially formed receiving area 42 of charger 14 and projects above a half of the power tool case that includes installation space 24, by way of which power tool case 10 is reliably prevented from being closed during a charging procedure.

Charger 14 includes a coupling unit 30 with two charging contacts 36, 38 in receiving area 26 designed to correspond with a coupling unit 32 of power tool 16—which also includes two charging contacts 40 located on diametrically opposed sides of power tool 16—and to transmit charging energy while power tool 16 is inserted in charger 14. Via coupling units 30, 32, a charging current is directed from charger 14 to power tool 16 and, in fact, to the integrated rechargeable battery.

Charger 14 also includes a wind-up device 20 for a power cord 22. Wind-up device 20 includes a rotatably supported storage means 44—designed in the shape of a cable drum—that is driven via a not-shown coiled spring. Storage means 44 of wind-up device 20 is located underneath receiving area 42 of charger 14 in an installation space 52, and power cord 22 is guided laterally out of an opening in installation space 52.

If power cord 22 is pulled on after power tool case 10 is opened, storage means 44 rotates and power cord 22 is unwound from storage means 44. At the same time, the not-shown coiled spring is preloaded. If the tension on power cord 22 is interrupted, a detent mechanism 54 snaps into support means 44, by way of which support means 44 is fixed in position against the spring force of the coiled spring. To wind power cord 22 onto support means 44, an actuating button 46 that triggers detent mechanism 54 and is located on the top side of charger 14 is pressed; support means 44 is driven by the coiled spring and power cord 22 is wound up.

The connection between charger 14 and power tool case 10 is designed to be detachable. Charger 14 is secured in installation space 24 via a detachable fastening means 18 in the form of a latching hook located on charger 14 and designed to be actuated without the use of tools. When charger 14 is located in installation space 24, fastening means 18 extends through a recess 48 in a housing wall of power tool case 10. To remove charger 14 from installation space 24, fastening means 18 must be pushed through recess 48 of the housing wall of power tool case 10 and thereby be elastically deflected. In the removed state, charger 14 can be used as it is in power tool case 10, in particular as a stand for power tool 16 (FIG. 4).

To reconnect charger 14 and power tool case 10, charger 14 is inserted—with its underside that faces away from the top side toward the front—into installation space 24 that is limited by a partition 56 in the direction of receiving area 12 of power tool 16. When charger 14 is moved into installation space 24, fastening means 18 strikes the housing wall of power tool case 10 and is elastically deflected. When charger 14 continues to move into installation space 24, fastening means 18 latches in recess 48 of the housing wall, and charger 14 is captively retained in installation space 24.

What is claimed is:

1. A device with a power tool case (10)—that includes at least one receiving area (12) for a power tool (16)—and a charger (14),
wherein
the charger (14) and the power tool case (10) are designed to remain connected during a charging procedure.

2. The device as recited in claim 1,
wherein
the power tool case (10) includes installation space (24) for the charger (14), and
the charger (14) is designed to remain in the installation space (24) of the power tool case (10) during the charging procedure.

3. The device as recited in claim 1,
wherein
the connection between the charger (14) and the power tool case (10) is designed to be detachable.

4. The device as recited in claim 3,
wherein
the charger (14) is connected with the power tool case (10) via at least one detachable fastening means (18).

5. The device as recited in claim 4,
wherein
the fastening means (18) is designed to be actuated without the use of tools.

6. The device as recited in claim 1,
wherein
the charger (14) includes a wind-up device (20) for a power cord (22).

7. A charger (14) for a device as recited in claim 1.

8. The charger (14) as recited in claim 7, characterized by the fact that it is designed as a stand for the power tool (16).

9. The charger (14) as recited in claim 8, characterized by a receiving area (26) in which the power tool (16) is capable of being positioned at least substantially in the machining direction (28).

10. The charger (14) as recited in claim 8, characterized by a coupling unit (30) that is designed to correspond with a coupling unit (32) of a power tool unit (16) while the stand function is being performed and to at least transmit charging energy.

11. A power tool case (10) for a device as recited in claim 1.
